(19) United States
(12) Patent Application Publication
(10) Pub. No.: US 2004/0204166 A1
(43) Pub. Date: Oct. 14, 2004

(54) Hands-free cradle with elevator assembly

(75) Inventor: Hyon S. Bae, Burlingame, CA (US)

Correspondence Address: JACOBSON HOLMAN, PLLC, THE JENIFER BUILDING, 400 SEVENTH STREET, NW, WASHINGTON, DC, 20004-2201, US

(73) Assignee: Youngbo Engineering, Inc.

(21) Appl. No.: 10/334,442

(22) Filed: Dec. 31, 2002

(51) Int. Cl. H04B 1/38

(52) U.S. Cl. 455/569.1; 455/90.1

(57) ABSTRACT

A hands-free cradle for receiving a mobile phone to enable hands-free operation of the mobile phone. The mobile phone has a data port for passing data signals and an antenna port for receiving antenna signals from an external antenna. The cradle includes a base assembly having a longitudinal axis. An elevator assembly is joined with the base assembly. The elevator assembly is shaped to receive the mobile phone. The elevator assembly is moveable along the longitudinal axis, when the mobile phone is received, to define an upper position and a lower position. A data connector protrudes from an opening, when the elevator assembly is moved to the lower position, to interface with the data port of the mobile phone. An antenna connector is situated to interface with the antenna port of the mobile phone when the mobile phone is received in the elevator assembly. The antenna connector moves with the elevator assembly along the longitudinal axis between the upper and lower positions.

### FIELD

The present invention relates generally to a cradle for receiving a mobile phone to enable hands-free operation of the mobile phone. More particularly, the present invention relates to a cradle which provides improved data coupling and antenna coupling when the mobile phone is received in the cradle.

### BACKGROUND

A conventional hands-free cradle is capable of receiving a communications device, such as a mobile phone, so a user can operate the communications device in a hands-free manner.

In one example, the hands-free cradle is provided in an automobile. The user enters the automobile and places a mobile phone in the hands-free cradle. A headset carrying a microphone and speaker is worn by the user. The headset is coupled to a headset output of the hands-free cradle. The headset output, in turn, is coupled to a phone interface in the cradle. When the phone interface is connected to the mobile phone, audio signals can be transmitted between the headset and mobile phone through the hands-free cradle. The user can interact with the mobile phone in a hands-free manner.

In another example, a speaker output of the hands-free cradle is connected to an audio system in the automobile. Speaker signals ordinarily sent to the headset speaker are routed to the audio system for broadcast over speakers in the automobile. Again, when the phone interface of the hands-free cradle is connected to the mobile phone, audio signals can be transmitted between the headset and mobile phone through the hands-free cradle, enabling the user to interact with the mobile phone in a hands-free manner.

The mobile phone generally includes a data port which provides a connection to external devices such as the hands-free cradle. The data port has data input/output (I/O) connections for passing data between the mobile phone and an external phone interface. In the examples above, the data port of the mobile phone has to be connected to the phone interface of the hands-free cradle for signals to be transmitted between the two devices.

Data ports of mobile phones can have different shapes. In one group of phone models, such as those currently offered by Nokia and Ericsson, the data port is essentially a row of spring-loaded pins which meets with a phone interface having a similar row of aligned pins. In a second group of phone models, such as those currently offered by Samsung, LG Electronics, and Motorola, the data port has a female shape. The phone interface of the hands-free cradle or external cable is shaped as a male connector to interface with the female shaped data port of these mobile phone models.

A problem exists with conventional hands-free cradles which receive phones with female shaped data ports. This problem involves coupling to the data port when the mobile phone is received in the cradle. Conventional hands-free cradles require that a control box be connected to the data port of the phone by a cable to transfer data signals to and from the phone. In the above examples, after inserting the phone in the cradle, the user has to perform the additional step of manually connecting the cable to the phone interface of the control box at one end, and to the data port of the mobile phone at the other end.

### SUMMARY

Aspects of the present invention relate to a hands-free cradle for receiving a mobile phone to enable hands-free operation of the mobile phone. The mobile phone has a data port for passing data signals and an antenna port for receiving antenna signals from an external antenna. The cradle includes a base assembly having a longitudinal axis. An elevator assembly is joined with the base assembly. The elevator assembly is shaped to receive the mobile phone. The elevator assembly is moveable along the longitudinal axis, when the mobile phone is received, to define an upper position and a lower position. A data connector protrudes from an opening, when the elevator assembly is moved to the lower position, to interface with the data port of the mobile phone. An antenna connector is situated to interface with the antenna port of the mobile phone when the mobile phone is received in the elevator assembly. The antenna connector moves with the elevator assembly along the longitudinal axis between the upper and lower positions.

### BRIEF DESCRIPTION OF THE FIGURES

The detailed description below may be better understood with reference to the following figures. The figures illustratively show one or more embodiments of the invention, and are not intended to limit the scope of the claims in any way. The components in the figures are not necessarily to scale, emphasis instead being placed upon clearly illustrating principles of the present invention. In the figures, like reference numerals designate corresponding parts throughout the several views.

FIG. 1A shows a perspective view of a hands-free cradle 100 in an upper position, constructed according to one embodiment of the present invention;

FIG. 1B shows a side view of hands-free cradle 100 in an upper position;

FIG. 2 shows a perspective view of hands-free cradle 100 receiving a mobile phone 202;

FIGS. 3A-3C show several views of a mobile phone 202 being inserted into hands-free cradle 100;

FIGS. 4A and 4B show a perspective view and a side view, respectively, of mobile phone 200 received by cradle 100;

FIGS. 5A and 5B show a perspective view and a side view, respectively, of hands-free cradle 100 in a lower position;

FIGS. 6A and 6B show a perspective view and a side view, respectively, of hands-free cradle 100 in the lower position;

FIG. 7A shows a perspective cutaway view of hands-free cradle 100;

FIG. 7B shows a front cutaway view of hands-free cradle 100 in the upper position;

FIG. 7C shows a front cutaway view of hands-free cradle 100 in the lower position;

FIG. 7D shows a detailed cutaway view of a latch assembly 700d when hands-free cradle 100 is in the upper position; and

FIG. 7E shows a detailed cutaway view of a latch assembly 700e when hands-free cradle 100 is in the lower position.

### DETAILED DESCRIPTION

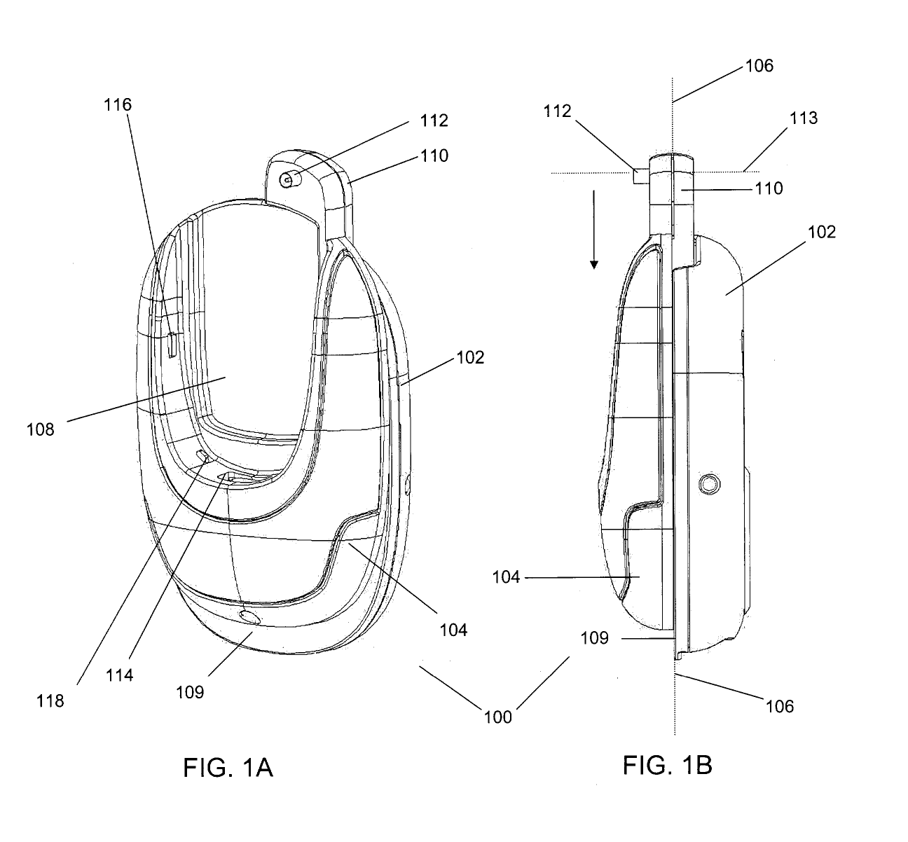

FIG. 1A shows a perspective view of a hands-free cradle 100. FIG. 1B shows a side view of hands-free cradle 100. The cradle 100 is capable of receiving a mobile phone to enable hands-free operation of the mobile phone.

In FIGS. 1A and 1B, the hands-free cradle 100 includes a base assembly 102 and an elevator assembly 104 joined with the base assembly to define an outer casing of the hands-free cradle 100. As shown in FIG. 1B, the hands-free cradle 100, including base assembly 102, has a longitudinal axis 106 oriented as shown.

In FIG. 1A, the elevator assembly 104 has a recessed portion 108 which is shaped to receive the mobile phone. An opening 114 is formed in an area of elevator assembly 104 which defines recessed portion 108. In the embodiment of FIG. 1A, the area, in which opening 114 is formed, is a curved wall defining a boundary of recessed portion 108. The opening 114 is further described below.

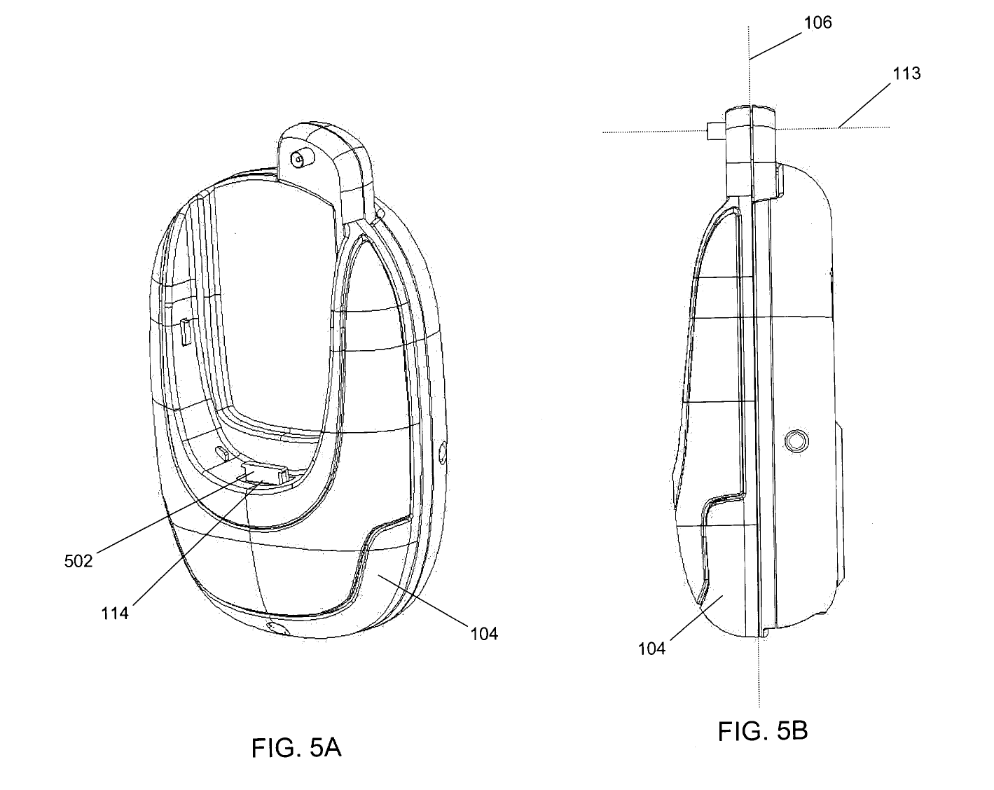

In FIGS. 1A and 1B, the elevator assembly 104 is positioned along a flat portion 109 of base assembly 102 to facilitate sliding or movement of elevator assembly 104 along longitudinal axis 106, when the mobile phone is received in recessed portion 108. As explained below, when the mobile phone is received in recessed portion 108, elevator assembly 104 can move from an upper position, shown in FIGS. 1A and 1B, along longitudinal axis 106, to a lower position shown in FIGS. 5A and 5B.

In FIGS. 1A and 1B, an antenna connection member 110 is shown as protruding from the outer casing defined by elevator assembly 104 and base assembly 102. In the embodiment of FIGS. 1A and 1B, the antenna connection member is attached to or molded as an extension of elevator assembly 104. In other embodiments, antenna connection member 110 is otherwise joined with or cooperates with elevator assembly 104 to be moveable with elevator assembly 104 along axis 106 between the upper and lower positions of FIGS. 1A, 1B and FIGS. 5A, 5B.

In FIGS. 1A and 1B, the antenna connection member 110 has an antenna connector 112. In one embodiment, the antenna connector 112 is oriented along an axis 113 perpendicular to longitudinal axis 106, as shown in FIG. 1B. In this way, antenna connector 112 is situated to interface with an antenna port of a mobile phone when the mobile phone is received in the recessed portion 108, as described below. In one example, the antenna connector is a coaxial RF connector.

In FIG. 1A, a latching mechanism, including upper latch 116 and a lower latch 118, is integral with elevator assembly 104. In FIG. 1A, latch 116 and latch 118 are positioned along the curved wall of elevator assembly 104 as shown, and counterparts to latch 116 and latch 118 are situated on the curved wall opposite latches 116 and 118 to define a pair of upper latches 116 and a pair of lower latches 118. The upper latches 116 are spring-loaded. In some embodiments, the latching mechanism includes other components which cooperate with either or both of latches 116, 118, as described below.

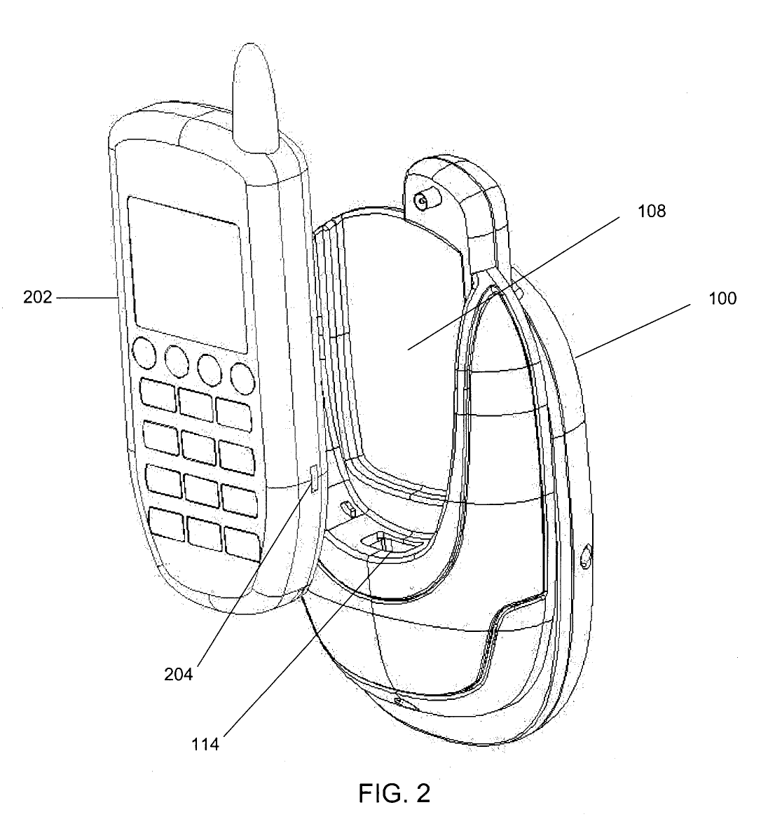

FIG. 2 shows hands-free cradle 100 receiving a mobile phone 202. Mobile phone 202 is any phone having a data port which can interface with a male data connector, or otherwise provides for a male-female I/O connection. In one example, shown in FIG. 2, the mobile phone 202 has a female-shaped data port situated on a lower side of the mobile phone 202 (not shown). The data port has connections for passing data signals, including audio signals such as speaker and microphone signals, and other data such as contact information, to and from the mobile phone 202. In some instances, the data port also provides connections for a power supply and ground (GND). When the data port interfaces with an external device, data signals can be passed between the external device and the mobile phone 202.

In FIG. 2, the recessed portion 108 of hands-free cradle 100 receives at least the part of mobile phone 202 having the data port, in FIG. 2, such that the data port of mobile phone 202 meets with opening 114 formed in elevator assembly 104. Mobile phone 202 includes an inlet 204 which receives latch 116 or 118 of hands-free cradle 100 when mobile phone 202 is received in the cradle.

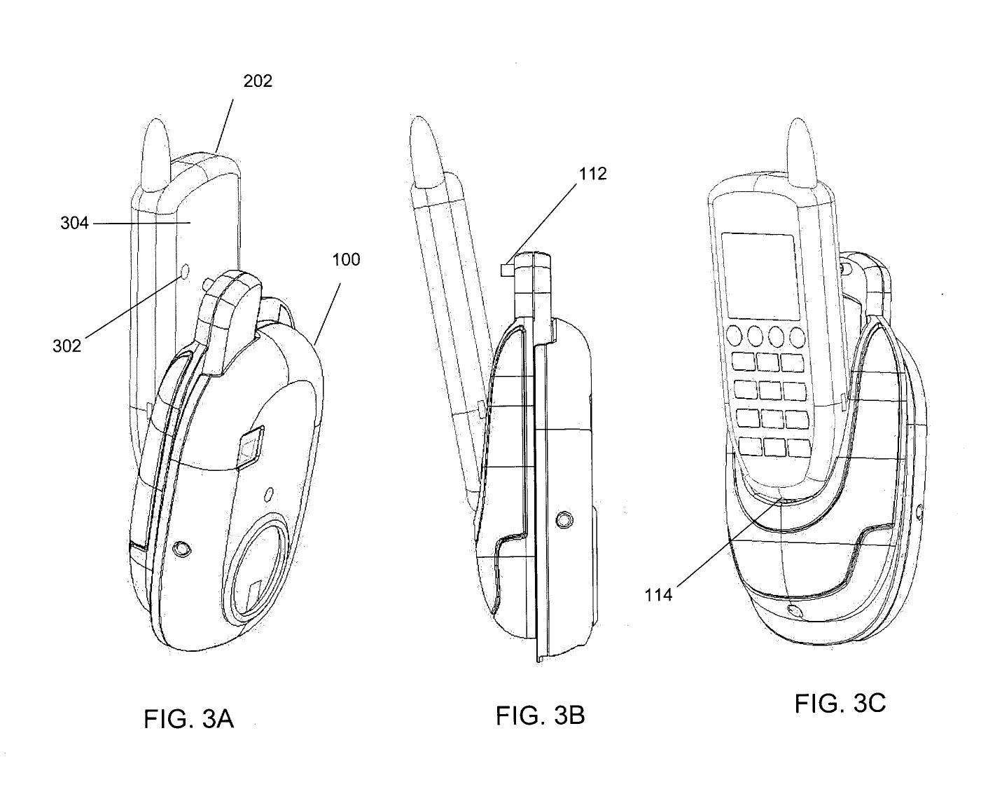

FIGS. 3A-3C show several views of mobile phone 202 and hands-free cradle 100 as the phone 202 is inserted in cradle 100. The mobile phone 202 has an antenna port 302 on a back side 304 of mobile phone 202. The antenna port 302 is a conventional jack provided in commercially available mobile phones, such as those described above, for receiving and sending antenna signals to an external antenna or antenna connector.

As illustrated in FIGS. 3A-3C, a user inserts mobile phone 202 into cradle 100. The opening 114 in cradle 100 meets with the data port of the mobile phone 202 when a lower portion of the mobile phone 202 is inserted in the recessed portion 108 of elevator assembly 104. As part of the same motion, an upper portion of mobile phone 202 moves toward antenna connection member 110. Antenna connector 112 then interfaces with antenna port 302, as shown in FIGS. 3A-3C.

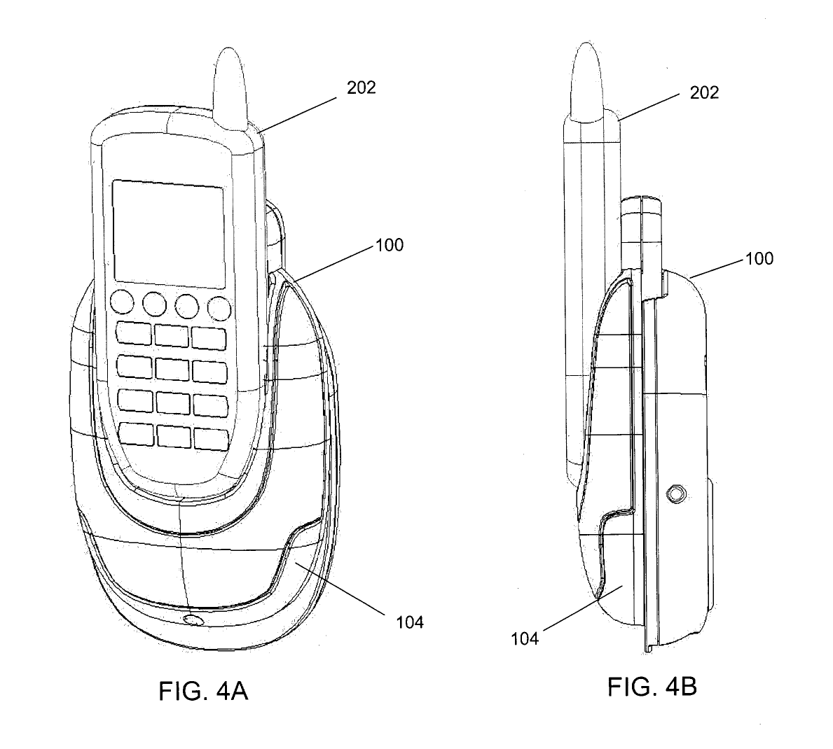

In FIGS. 4A and 4B, the mobile phone 202 is shown as received in recessed portion 108 of the elevator assembly 104. The data port of mobile phone 202 faces opening 114, and antenna connector 112 has met with antenna port 302 of mobile phone 202. In FIGS. 4A and 4B, elevator 104 is still in the upper position.

FIGS. 5A and 5B show views of hands-free cradle 100 in the lower position. FIGS. 5A and 5B show that the elevator assembly 104 has moved from the upper position of FIGS. 1A and 1B, along the longitudinal axis 106, to the lower position. The mobile phone 202 has been removed from FIGS. 5A and 5B for purposes of illustration only. Generally, mobile phone 202 is received in recessed portion 108 when elevator assembly 104 is in the lower position.

In FIG. 5A, a data connector 502 is shown. The data connector 502 has connectors which are aligned to interface with the audio, data, power, ground, and possibly other connections in the data port of mobile phone 202. The data connector 502 is preferably fixed relative to base assembly 102 and situated with respect to opening 114 formed in elevator assembly 104 such that data connector 502 protrudes from opening 114 when elevator assembly 104 has moved from the upper position to the lower position. In this way, data connector 502 interfaces with the data port of mobile phone 202 when mobile phone 202 moves with elevator assembly 104 from the upper to the lower position.

The protrusion of data connector 502 can be viewed by contrasting FIG. 1A with FIG. 5A. In FIG. 1A, when elevator assembly 104 is in the upper position, data connector 502 is hidden within opening 114 of elevator assembly 104. In FIG. 5A, when elevator assembly 104 has moved to the lower position, data connector 502 juts out from opening 114. Thus, when data connector 502 mates with the data port of mobile phone 202, data and other signals can be passed between hands-free cradle 100 and mobile phone 202 through the data connector 502.

As shown in FIG. 5B, antenna connection member 110 has moved with elevator assembly 104 along longitudinal axis 106 from the upper position to the lower position. This movement is shown by contrasting FIG. 5B and with FIG. 1B.

FIGS. 3A-3C and 5A-5B show that hands-free cradle 100 provides both antenna coupling and data coupling with mobile phone 202 along two axes. When elevator assembly 104 is in the upper position, in FIGS. 3A-3C, antenna port 302 of mobile phone 202 connects with antenna connection member 110 along perpendicular axis 113. When elevator assembly 104 moves to the lower position, in FIGS. 5A and 5B, data connector 502 protrudes from opening 114 and connects with the data port of mobile phone 202 along longitudinal axis 106.

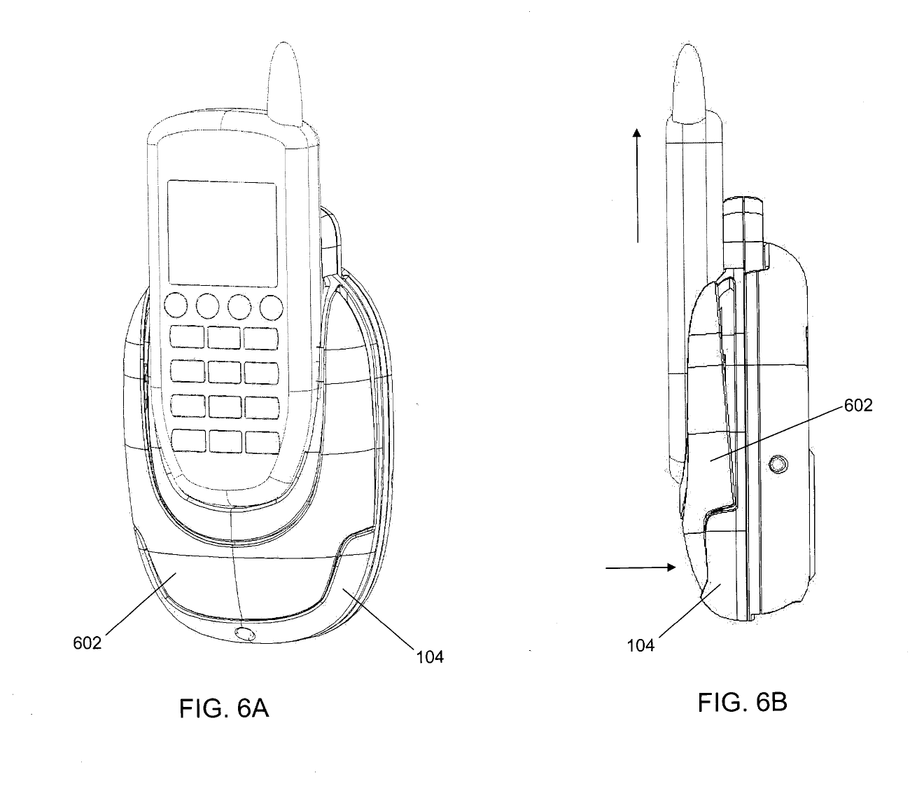

FIGS. 6A and 6B show part of an exemplary elevator release mechanism which cooperates with elevator assembly 104. The elevator release mechanism includes a conventional locking apparatus, within the outer casing of cradle 100, which locks elevator assembly 104 in place when elevator assembly 104 is moved from the upper position to the lower position. When the elevator release mechanism is activated, the locking apparatus is disengaged to release the elevator assembly 104. In this way, elevator assembly 104 can move back to the upper position.

In one embodiment, the elevator release mechanism includes a molded button 602 shaped as shown in FIGS. 6A and 6B. In an alternative embodiment, in place of molded button 602, is a button of some other shape protruding from the outer casing of hands-free cradle 100. The button is located, for instance, on a side of the cradle 100 or on some part of elevator assembly 104. In another alternative embodiment, a switch is used in place of the button or molded button 602. When button 602 of the elevator release mechanism is pressed, the locking apparatus is released, allowing the elevator assembly 104 to move from the lower to the upper position.

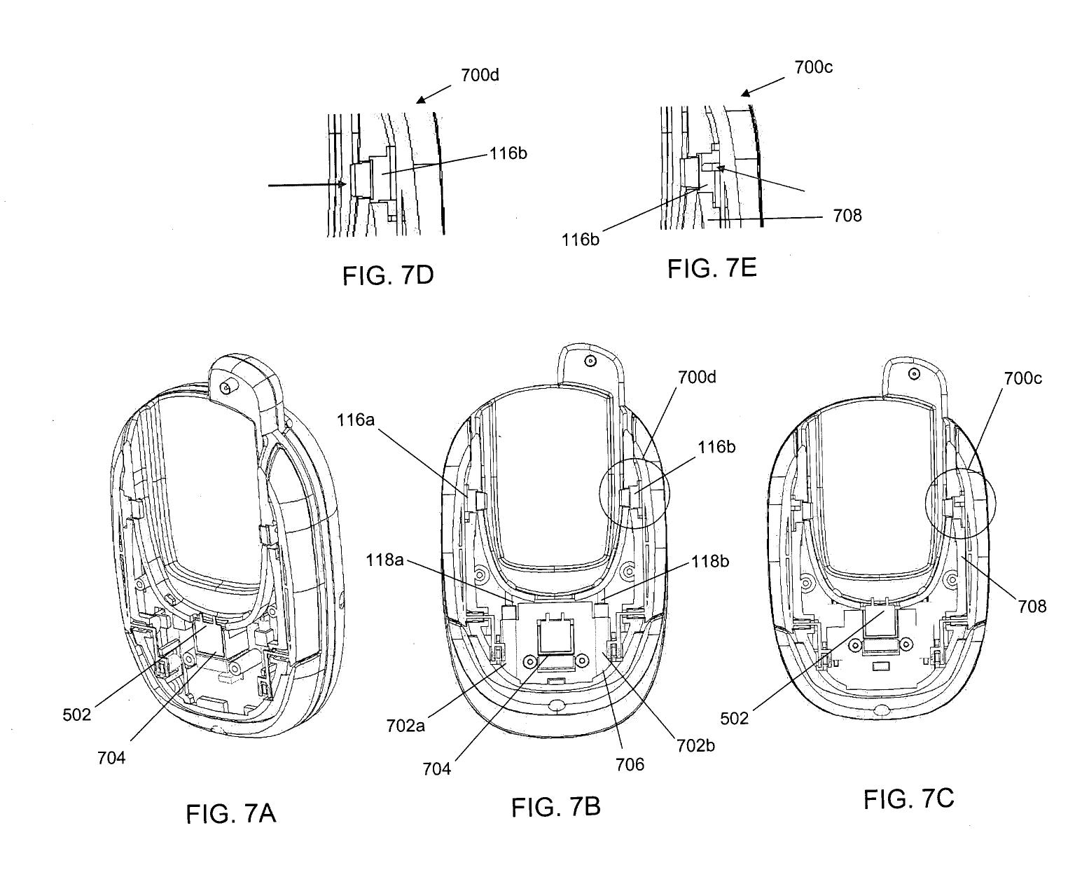

In FIGS. 7A-7C, within the outer casing of hands-free cradle 100 is a spring assembly 702 comprising two cylindrical compression springs 702a, 702b. As shown in FIG. 7B, springs 702a and 702b are situated on respective sides of a housing unit 704 in which data connector 502 is seated. In one example, the spring assembly 702 is seated between a fixed part 706 of base assembly 102 and lower latches 118a and 118b of elevator assembly 104. When released, the compression springs 702a and 702b exert a force against elevator assembly 104 upwards along longitudinal axis 106 from the lower position towards the upper position.

The elevator release mechanism described with respect to FIGS. 6A and 6B interacts with spring assembly 702 so that the compression springs 702a and 702b are released when the elevator release mechanism 600 is activated. Thus, in one example, when a user pushes the molded button 602 of the elevator release mechanism, as shown in FIGS. 6A and 6B, the locking apparatus releases the compression springs, forcing the spring loaded elevator assembly 104 to move from the lower position of FIGS. 5A and 5B to the upper position of FIGS. 1A and 1B. By the same token, when the elevator assembly 104 and mobile phone 202 are pushed along longitudinal axis 106 from the upper position into the lower position, the locking apparatus of the elevator release mechanism retains the compression springs until the elevator release mechanism is again activated.

FIG. 7D shows a detailed cutaway view of latch assembly 700d when elevator assembly 104 is in the upper position. In FIG. 7D, the spring-loaded upper latch 116 is free to move. Thus, when elevator assembly 104 is in the upper position, the user can easily insert and remove mobile phone 202 from hands-free cradle 100.

FIG. 7E shows a detailed cutaway view of the latch assembly 700e when elevator assembly 104 is in the lower position. When elevator assembly 104 moves from the upper position to the lower position, a latch locking arm 708, fixed along one side of base assembly 102 within the outer casing, is moved behind upper latch 116b as shown. The latch locking arm 708 thus locks upper latch 116b in place. In this way, when elevator assembly 104 is in the lower position, movement of latch 116b is restricted. In one example, latch locking arms on opposite sides of base assembly 102 restrict movement of the upper latches 116a and 116b, respectively, when the elevator assembly is in the lower position. Thus, the mobile phone 202 is locked into hands-free cradle 100 and cannot be removed until elevator assembly 104 is moved back to the upper position.

The components described above cooperate with one another to retain mobile phone 202 and lock the elevator assembly 104 in place when elevator assembly 104 is in the lower position, and release the elevator assembly to move to the upper position for removal of the mobile phone 202. Thus, the lower position can be referred to as a “locked” position, and the upper position can be referred to as an “unlocked” position.

It should be emphasized that the above-described embodiments of the invention provide examples for a clear understanding of the principles of the invention. Variations and modifications can be made to the above-described embodiments of the invention without departing from the spirit and principles of the invention, as will be understood to those skilled in the art. All such modifications and variations are intended to be included within the scope of the invention and protected by the following claims.

What is claimed is:

1. A hands-free cradle for receiving a mobile phone to enable hands-free operation of the mobile phone, the mobile phone having a data port for passing data signals and an antenna port for receiving antenna signals from an external antenna, the hands-free cradle comprising:
a base assembly having a longitudinal axis;
an elevator assembly joined with the base assembly to form an outer casing, the elevator assembly having a recessed portion, the recessed portion shaped to receive at least a part of the mobile phone having the data port, the elevator assembly moveable along the longitudinal axis, when the mobile phone is received in the recessed portion, to define an upper position and a lower position;
an antenna connection member having an antenna connector situated to interface with the antenna port of the mobile phone when the mobile phone is received in the recessed portion of the elevator assembly in the upper position, the antenna connection member moveable with the elevator assembly along the longitudinal axis; and
a data connector fixed relative to the base assembly, the data connector situated with respect to the data port of the mobile phone and to an opening formed in an area of the elevator assembly defining the recessed portion of the elevator assembly such that the data connector protrudes from the opening, when the elevator assembly is in the lower position, to interface with the data port of the mobile phone.

2. The hands-free cradle of claim 1, wherein the antenna connector is a coaxial connector.

3. The hands-free cradle of claim 1, wherein the antenna connector is oriented perpendicular to the longitudinal axis of the base assembly.

4. The hands-free cradle of claim 1, wherein the data connector includes an audio connection.

5. The hands-free cradle of claim 1, wherein the data connector includes a data connection.

6. The hands-free cradle of claim 1, wherein the data connector includes a power connection and a ground connection.

7. The hands-free cradle of claim 1 further comprising a latch situated on a part of the elevator assembly defining the recessed portion.

8. The hands-free cradle of claim 7, wherein the latch is spring loaded.

9. The hands-free cradle of claim 7, wherein the latch is moveable when the elevator assembly is in the upper position.

10. The hands-free cradle of claim 7, wherein the latch is locked when the elevator assembly is in the lower position.

11. The hands-free cradle of claim 7 further comprising a latch locking arm which cooperates with the latch to allow the latch to be moveable when the elevator assembly is in the upper position, and to retain the latch when the elevator assembly is in the lower position.

12. A hands-free cradle for receiving a mobile phone to enable hands-free operation of the mobile phone, the mobile phone having a data port for passing data signals and an antenna port for receiving antenna signals from an external antenna, the hands-free cradle comprising:
a base assembly having a longitudinal axis;
an elevator assembly joined with the base assembly to form an outer casing, the elevator assembly having a recessed portion, the recessed portion shaped to receive at least a part of the mobile phone having the data port, the elevator assembly moveable along the longitudinal axis, when the mobile phone is received in the recessed portion, to define an upper position and a lower position;
an antenna connection member protruding from the outer casing, the antenna connection member having a coaxial antenna connector oriented perpendicular to the longitudinal axis of the base assembly, the coaxial antenna connector situated to interface with the antenna port of the mobile phone when the mobile phone is received in the recessed portion of the elevator assembly in the upper position, the antenna connection member in cooperation with the elevator assembly to be moveable with the elevator assembly along the longitudinal axis;
a data connector fixed relative to the base assembly, the data connector situated with respect to the data port of the mobile phone and to an opening formed in an area of the elevator assembly defining the recessed portion of the elevator assembly such that the data connector protrudes from the opening, when the elevator assembly is in the lower position, to interface with the data port of the mobile phone;
a latching mechanism in cooperation with the elevator assembly to be engaged to retain the mobile phone when the elevator assembly is in the lower position, and disengaged when the elevator assembly is in the upper position; and
an elevator release mechanism in cooperation with the elevator assembly and a locking apparatus which locks the elevator assembly in the lower position, the elevator release mechanism capable of being activated to release the locking apparatus, and a spring assembly forcing the elevator assembly from the lower position towards the upper position along the longitudinal axis when the elevator release mechanism is activated.

13. The hands-free cradle of claim 12, wherein the antenna connector is a RF connector.

14. The hands-free cradle of claim 12, wherein the data connector includes an audio connection.

15. The hands-free cradle of claim 12, wherein the data connector includes a data connection.

16. The hands-free cradle of claim 12, wherein the data connector includes a power connection and a ground connection.

17. The hands-free cradle of claim 12, wherein the elevator release mechanism includes a button capable of being pressed to activate the elevator release mechanism.

18. The hands-free cradle of claim 12, wherein the elevator release mechanism includes a switch capable of being pressed to activate the elevator release mechanism.

19. The hands-free cradle of claim 12, wherein the spring assembly includes a spring.

20. The hands-free cradle of claim 19, wherein the spring is situated between a lower latch of the latching mechanism and a fixed part of the base assembly.

21. The hands-free cradle of claim 12, wherein the latching mechanism includes a pair of upper latches situated on opposite sides of a curved wall defining the recessed portion, and a pair of lower latches situated on opposite sides of the curved wall.

22. The hands-free cradle of claim 21, wherein the upper latches are spring loaded.

23. The hands-free cradle of claim 21, wherein the upper latches are moveable when the elevator assembly is in the upper position.

24. The hands-free cradle of claim 21, wherein the upper latches are locked when the elevator assembly is in the lower position.
